(19) United States
(12) Patent Application Publication
(10) Pub. No.: US 2003/0161781 A1
(43) Pub. Date: Aug. 28, 2003

(54) Novel carbon materials and carbon/carbon composites based on modified poly (phenylene ether) for energy production and storage devices, and methods of making them

(76) Inventors: Israel Cabasso, Syracuse, NY (US); Han Liu, Waltham, MA (US); Suoding Li, Syracuse, NY (US); Youxin Yuan, Syracuse, NY (US)

Correspondence Address: MORGAN & FINNEGAN, L.L.P., 345 Park Avenue, New York, NY, 10154-0053, US

(21) Appl. No.: 09/968,290

(22) Filed: Oct. 1, 2001

(51) Int. Cl. C01B 31/02

(52) U.S. Cl. 423/445 R; 29/25.03; 502/418; 502/101

(57) ABSTRACT

It is MPPE based polymeric carbon materials with high electric and gas conductivity, large surface area with narrow pore size distribution, good mechanical strength, versatile applications and ease of manufacturing. The carbon material can be in the form of carbon powder, carbon fiber reinforced sheets or other types of carbon/carbon composites. This carbon material can be readily utilized in/as base materials for catalysts, adsorbent, water treatment materials, electrodes for double layer capacitors, fuel gas storage materials and fuel cell gas diffusion electrodes. The carbon is produced by oxidation of poly(phenylene ether) (PPE) in air or other oxygen containing atmospheres at temperatures near the glass transition temperature of PPE, followed by carbonization of the oxidized material in an inert atmosphere at elevated temperatures (400-3000° C.) and activating the carbon materials with steam, carbon dioxide, oxygen containing gases, organic or inorganic bases and organic or inorganic acids. The carbon is characterized by high electric conductivity and high surface area with controllable pore size distribution. The method also involves modification of the original polymer with an oxidization process, forming the preform by casting, molding or extruding a mixture of polymer and other carbon materials, carbonizing the preform at elevated temperatures and activating such materials as aforementioned.

### FIELD OF INVENTION

This invention relates to novel carbon materials with high electric conductivity and extremely high surface area with controllable pore size distribution and carbon/carbon composites that are based on modified poly(phenylene ethers, and their use in adsorption applications such as anti-pollution devices, fuel gas storage, and electrochemical applications, such as electrode and current collectors for double layer capacitors and lithium-ion batteries, gas diffusion electrodes for fuel cells. Further, this invention also relates to methods of preparing the novel carbon materials and carbon/carbon composites.

### BACKGROUND OF THE INVENTION

Carbon, in various forms, is used for many electrochemical and adsorption applications. Carbon has good electric conductivity, while its low chemical reactivity makes it potentially a more desirable candidate than metals for many electrochemical applications. Carbon materials have enough durability to sustain strong oxidizing and reducing environments inside energy conversion and energy storage devices, such as fuel cells, double layer capacitors or lithium-ion batteries. One of the advantages of carbon material is that it can be prepared to have very high surface area, which makes it useful: for adsorption related applications; for purification of industrial gases; in anti-pollution devices; for gas separation; for liquid-phase purification processes in the food and chemical industries; for liquid-phase recovery and separation; as a catalyst or catalyst support material; and for analytical and medicinal applications.

Carbon materials may be formed by pyrolyzing polymers at very high temperatures in a non-oxidative atmosphere. To enhance the surface area of the carbon material, it may be treated further to produce an activated carbon material. Carbon materials also may be produced from naturally occurring raw materials, such as coal tar pitch, oil, petroleum pitch, peat, wood and other sources of high carbon content. Activated carbon made from such carbon materials is used for waste water treatment, air purification and other industrial applications. The Safe Drinking Water Act Amendments officially identify the activated carbon adsorption as the best available technique for portable water supplies.

A major advantage of carbons prepared from naturally occurring raw materials is the relatively low cost of such naturally occurring raw materials. While naturally occurring raw materials are natural precursors for carbon, they contain large amounts of impurities such as sulfur, nitrogen, phosphor and metal salts, which generally reside in the material during and after the carbonization process, and are difficult to remove. When carbon material is employed in critical applications, such as lithium-ion batteries, fuel cells or double layer capacitors, such impurities may introduce side reactions which lower performance, deteriorate structure, shorten lifetime and poison any catalyst they may carry (e.g., platinum supported by carbon).

Historically, polyacrylonitrile (PAN), the major precursor of carbon fibers, and other precursors such as pitch, phenolic resin, and polyacetylenes, have been employed for making carbon from synthetic polymers. Most carbon fibers in the market today are prepared from PAN. The drawback of carbons made from the aforementioned precursors is that the carbon has a low surface area in the absence of a subsequent activation process. Both the PAN and phenolic resin based carbon material have a very low surface area, if no further activation is employed. While activation may not be a major concern for powderous carbon, it can distort, introduce defects or completely destroy a formed carbon body. Consequently, it is highly desirable to develop a polymeric carbon (a type of carbon prepared by carbonization of carbon forming precursor polymers) with higher surface area, narrow pore size distribution, good electric conductivity and satisfactory mechanical strength.

To enhance the surface area of carbon, activation is always employed after the carbonization process. The activation of carbon can be categorized into two major types: physical activation and chemical activation. The activation agents employed by physical activation are steam, carbon monoxide (CO), carbon dioxide (CO₂), and CO₂-containing gases. ZnCl₂, H₂SO₄, H₃PO₄, NaOH, LiOH or KOH are generally employed during the chemical activation. Also, NₓO_{y}[x=1-2, y=1-3], Cl₂ and other halogens, and mixtures thereof are considered activation agents. Further, the activation of carbon introduces many oxygen containing surface groups which modify the surface properties, such as hydrophilicity, of the carbon. Various types of surface groups, such as carboxyl, carbonyl, phenol, quinone, and lactone, have been identified on the carbon surface.

U.S. Pat. No. 4,769,359 to Audley, et al. describes the preparation of activated carbon by treating finely divided coal with a hot liquid mixture comprising KOH and NaOH in a molar ratio of NaOH to KOH of from 80:20 to 20:80. The activation temperature is said to be more than 500° C. and the activation is conducted in an inert atmosphere.

U.S. Pat. No. 5,064,805 to Otowa describes the preparation of an activated carbon with a BET surface area in excess of 2000 m²/g by adding coconut shells into a liquid melt of KOH, in a weight ratio of 1:2 through 1:6, and heating at an elevated temperature that is sufficiently high for the activation of carbon. Such carbon is said to have a low sulfur content compared to activated carbon based on petroleum coke. A BET surface area of 2680 m²/g is obtained with a weight loss of 60 wt % during the activation process; the total pore volume is 1.68 ml/g with a micropore volume of 0.37 ml/g. A total sulfur content of 86 ppm is reported.

A highly microporous activated carbon for the storage of gaseous hydrocarbon fuels is disclosed in U.S. Pat. No. 5,710,092 to Baker. An activated carbon based on lignocellulosic materials is mixed with aqueous KOH solution, which is subsequently dried to a moisture content of less than 25% before being heated to a temperature of approximate 650° C.-1100° C. The maximum BET surface area is reported to be about 2400 m²/g with a micropore volume of less than 20 Å pore with an average width of 0.84 cc/g.

A major disadvantage of carbon is its poor formability. Most metals can be machined readily or cast into different shapes. However, carbon is very difficult to manipulate because it is very brittle and will not melt. Polymeric carbons were developed to partially solve the problem. A polymer is first prepared into a desired form, such as sheets, and subsequently, the desired polymer form is carbonized to produce a carbon body with the designed shape. Carbon sheets prepared from polymer fibers, specifically derivatives of polyacrylonitrile (PAN), are described in U.S. Pat. No. 4,919,860 to Erich Schindler, et al.

U.S. Pat. No. 4,426,470 to Richard A. Wessling, et al. describes one technique to deal with carbon's inherent brittleness by mixing carbon particles or fibers with polymers. Polymers have excellent formability and they generally can be deformed at temperatures much lower than the temperatures at which metals are deformed. U.S. Pat. No. 5,366,825 to Moritz Braun, et al. describes the use of fluorine-containing polymers, such as poly(vinylidene fluoride) and polytetrafluoroethylene, as the binder because of their high stability when application of the material is electrically related. As a dielectric material, however, polymers inevitably increase resistance of a formed body. With increased polymer content, the strength of the formed body increases, but its electrical conductivity decreases. Another disadvantage of using polymers in formed bodies as dielectrics is that most polymers are not stable enough for critical applications involving high temperature or strong acidic environments. Aging of polymers also affects the life span of the formed body.

Carbon has been employed in polymer bonded particles for many real-world applications including fuel cells, for example, polymer/carbon gas diffusion electrodes. Instead of polymers, carbon itself can be utilized to bond carbon particles together. For example, U.S. Pat. No. 5,366,825 to Richard D. Breault, et al. describes mixing a designated polymer with carbon particles or fibers and casting the mixture into a formed body. Then, the formed body is heated to a high temperature in an inert atmosphere to carbonize the polymer, the polymeric carbon bonding the carbon particles and fiber together while maintaining the shape of the formed body.

Carbon materials, including carbon black and carbon/carbon composites, play an important role in fuel cell technology. The basic components of a polymer electrolyte membrane (PEM) fuel cell consist of a PEM sandwiched between two gas diffusion electrodes. The gas diffusion electrode is a carbon composite containing a carbon supported catalyst, for example a carbon supported platinum catalyst. Fuel cells represent a unique efficient energy source with no emissions and efficiencies that are not bound by the Carnot cycle (Mantell, C. L. in Batteries And Energy Systems, McGraw-Hill: New York, 1983). It has also been reported that with increasing environmental concerns of conventional power generating devices, the development of fuel cells in transportation and stationary applications has intensified (Ye, et al. Electrochem. Soc. 144:90-95, 1997).

Porous carbon paper is a porous, two-dimensional carbon/carbon composite fabricated mainly from carbon fiber paper substrate and polymer precursors. It has been used as a substrate in gas diffusion electrodes of fuel cells. As a substrate of a gas diffusion electrode for a fuel cell, carbon paper must have good electric conductivity, high gas permeability and high mechanical strength.

During preparation of carbon paper, various fabric materials have been employed as the substrate. Such fabric materials have generally been in the form of sheets that can be categorized into two types: (1) polymer (including natural polymer such as cellulose) fabric based materials, as described in U.S. Pat. No. 3,998,689 to Kitago Teruaki, et al.; and (2) carbon fiber sheets or carbon fiber papers, as described in U.S. Pat. No. 3,649,196 to Degginger Edward Reinauer. Such materials have generally been prepared by paper making methods.

U.S. Pat. No. 4,8851,304 to K. Miwa, et al. describes phenolic resin based carbon papers that were commercialized by Toray Industries, Inc. in 1989. Many researchers in the field of fuel cells have adopted Toray® carbon paper for gas diffusion electrode fabrications because of its high conductivity and high gas permeability. The disadvantage of such phenolic resin based carbon papers is that they are relatively brittle since phenolic resin forms a glassy carbon. Another disadvantage of these carbons is that their conductivity improves mainly in the high temperature range, from 1800-2200° C., which is out of the temperature range of conventional furnaces. This ultimately increases manufacturing costs and energy consumption. Also, surface area of a phenolic resin based carbon is very low; heavy activation must be employed if a high surface area, phenolic resin based carbon is desired.

An object of this invention is to provide novel carbon materials made from polymer precursors and having a high carbon content.

An object of this invention is to provide a method of making a carbon material or carbon/carbon composite that obviates disadvantages of the kinds described above.

Another object of this invention is to provide a new type of highly electric conductive carbon or carbon/carbon composite that has a high surface area with a controllable pore size distribution, especially in the micropore range.

Another object of this invention is to provide a new type of carbon or carbon/carbon composite that has a long lifetime, low strength deterioration and is easy to manufacture.

Still another object of this invention is to provide a new type of carbon or carbon/carbon composite whose elementary composition can be controlled to be free of impurity elements other than carbon, hydrogen and oxygen, or one or more doping elements that optionally may be introduced into the composition.

It is a further object of the present invention to provide new carbon materials in the form of powders, carbon sheets, formed bodies, and a method of producing such materials.

Yet another object of this invention is to provide a new carbon/carbon composite that can be fabricated into different sizes and shapes based on the requirements of specific applications.

A further object of this invention is to provide a carbon based material that can be utilized in adsorption related applications such as anti-pollution devices to remove trace quantities of organic compounds in water; gas storage devices for hydrogen, methane, etc.; as a base or main material of catalytic substances and other applications that demand a high surface area with a controlled pore size distribution.

Still another object of the present invention is to provide a method of fabricating the aforementioned materials with relatively easy and highly efficient procedures that can be readily commercialized in a large-scale production.

Yet a further object of this invention is to provide methods of using the novel form of carbon or carbon/carbon composite for various energy production and energy storage processes, such as electrodes and current collectors for fuel cells, hydrogen, methane and other fuel and gas storage, other adsorbent compounds and electrodes for double layer capacitors.

### SUMMARY OF THE INVENTION

The objectives and the criteria for the novel carbon materials, with high surface area and controllable and/or narrow pore size distribution, high electric conductivity, controlled elemental composition, can be achieved by practice of this invention. In one aspect, the invention concerns a carbon material having a porosity from 10 to 90 percent, a maximum pore diameter from 0.00015 to 500 micrometers (μm), the preponderance of the pore diameters being below 2 nanometers (nm), a BET surface area before activation between 500 m²/g and 700 m²/g and comprising 20-99.99 weight percent of carbon, preferably 60-99.99 weight percent of carbon.

In another aspect, this invention concerns a carbon/carbon material composite, preferably a modified-PPE carbon material in which the carbon material of this invention binds carbon particles together, the carbon material bonding carbon particles, and or fibers, together, while maintaining the shape of the composite. Further, the composite comprises a BET surface area prior to activation between 500 m²/g and 4200 m²/g.

In another aspect, this invention concerns an improved fuel cell containing two electrodes with an electrolyte disposed therebetween, an improvement in which the electrodes comprise the carbon material of this invention, the fuel cell electrode having high electrical conductivity.

In yet another aspect, this invention concerns how the carbon material of this invention improves a double layer capacitor containing two porous carbon electrodes sandwiched between an ionic conductive electric insulator with an electrolyte exposed therebetween, the improvement wherein the electrodes comprises the carbon material of this invention. Advantages of the double layer capacitor are: an extremely small distance between two layers of charges; and the increased area of the two charged layers, wherein materials having a high internal surface area can be utilized since the double layer can also be formed inside the body of the electrodes. Further, the invention comprises a double layer capacitor that has a specific capacitance ranging from 1-200 F/g, preferably greater than 55 F/g; is easily manufactured and assembled, and is virtually maintenance free.

In another aspect, this invention concerns a method of preparing an activated carbon from a modified poly(phenylene ether) precursor having a chemical structure characterized by the following recurring unit:

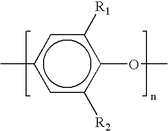

wherein R1 and R2 are each the same or different and are selected from the group consisting of hydrogen, an aliphatic group, an aromatic ether, an aliphatic or aromatic ester, a ketone, a lactone, and a xanthone; intermolecular and intramolecular linkages exist between the R1 and R2 groups in the modified poly(phenylene ether) and n is an integer between 10 and 10,000, the method comprising:

a) oxidizing the precursor polymer in an oxidizing atmosphere, at an elevated temperatures between 50° C. and 450° C. for a time period sufficient to crosslink the PPE polymer to form a modified-poly(phenylene ether) as defined hereinabove; and

b) carbonizing the modified poly(phenylene ether) at a temperature between 400° C. and 3000° C. in a non-oxidizing atmosphere for a time period sufficient to form a carbon powder material having a BET surface area before activation between 500 m²/g and 700 m²/g and comprising 20-99.99 weight percent carbon, preferably 60-99.99 weight percent carbon.

In another aspect, this invention concerns a method of preparing an activated carbon from a modified poly (phenylene ether) MPPE precursor as defined above, the method further comprising the steps:

c) mixing the carbon powder with an alkali metal hydroxide pellet(s) or powder, wherein the alkali metal is selected from the group consisting of lithium, sodium, and potassium; or mixing the carbon powder with an alkali metal solution in an alkali metal to carbon ratio of 1:10 to 12:1 (on a dry weight basis);

d) transferring the mixture to a container, preferably made of nickel, stainless steel, or other oxidation resistant material, and heating the mixture from 450° C. to 1100° C. under nitrogen protection in an inert atmosphere for 0.1 to 10 h; and

e) flushing water and acid solution through the carbon mixtures to clean the activated carbon material.

In yet another aspect, this invention also concerns a method of preparing an activated carbon, preferably by steam, from a modified poly (phenylene oxide ether) precursor polymer as defined above, the method comprising:

a) oxidizing the precursor polymer, preferably a powderous precursor polymer, in an oxygen containing atmosphere at an elevated temperature between 50° C. and 450° C. for a time period sufficient to crosslink the PPE polymer to form a modified-PPE, as defined hereinabove;

b) carbonizing the modified poly(phenylene ether) at a temperature between 400° C. and 3000° C. in a non-oxidizing atmosphere for a time period sufficient to form carbon powder material having a BET surface area before activation between 500 m²/g and 700 m²/g and comprising 20-99.99 weight percent carbon, preferably 60-99.99 weight percent carbon.

c) transferring the carbon to a furnace, preferably a rotary furnace, where a stream of steam/nitrogen mixture, in a molar ratio ranging from 1:4 to 6:1, is passed through; and

d) activating the carbon at elevated temperatures ranging from 300° C. to 1100° C. for 0.1 to 10 h.

Alternatively, a carbon/carbon composite can be prepared based on a method comprising:

a) forming a carbon fiber fabric with an organic fibrous binder selected from the group consisting of cellulose, cellulose ethers, cellulose ether derivatives, polyacrylonitrile (PAN), oxidized PAN, phenolic resin, polyvinyl acetate (PVA), epoxides, and combinations thereof.

b) forming a solution of poly(phenylene ether) or a slurry from mixing the PPE solution with other carbonous materials;

c) applying said poly(phenylene ether) solution to said carbon fiber fabric to form a composite;

d) drying the thus-formed composite, comprising PPE applied to the carbon fiber fabic;

e) pressing said dried composite under a pressure between 1 and 100,000 psig;

f) oxidizing said pressed composite in an oxidizing atmosphere, preferably air, at an elevated temperature between 100° C. and 420° C. for a time period (typically between 0.1 h and 72 h) sufficient to crosslink the PPE polymer to form a modified-PPE as defined hereinabove; and.

g) carbonizing the modified poly(phenylene ether) at a temperature between 500° C. and 3000° C. in a non-oxidizing atmosphere for a time period sufficient to form a carbon material comprising 20-99.99 weight percent carbon, preferably 60-99.99 weight percent carbon, wherein said carbon material can be used as a modified electrode; and

h) activating the modified poly(phenylene ether) electrode with one selected from the group comprising oxidizing gases, bases or acids at elevated temperatures.

### BRIEF DESCRIPTION OF THE DRAWINGS

FIG. 1 is a flow chart illustrating steps of a method of forming a carbon material/carbon composite of this invention.

FIG. 2 is a graph illustrating the electrical conductivity in S/cm of a high density (H) carbon fiber paper, a 102 g/m² carbon fiber sheet, and a 68 g/m² carbon sheet.

FIG. 3 is a graph showing the carbon yield in weight percent vs. the oxidation temperature in ° C. and heating rate in ° C./min for a carbon material prepared according to applicants' invention.

FIG. 4 is a graph showing the pore volume in cc/g×10⁻³ of a non-activated carbon material of this invention versus the pore diameter of the carbon material.

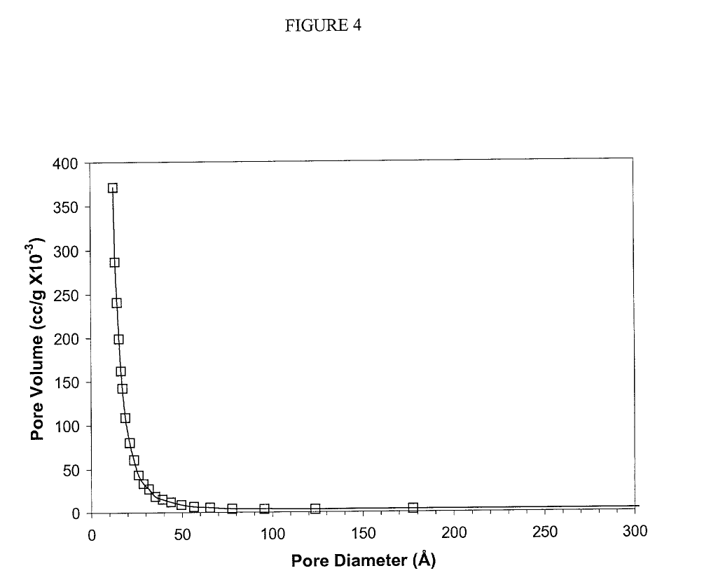

FIG. 5 is a graph showing the volume adsorbed at standard temperature and pressure, i.e., 77 K and ambient pressure in cc/g by a 0.0328 g of carbon material of this invention of nitrogen measured versus the relative vapor pressure (P/P₀) of the nitrogen.

FIG. 6 is a graph showing the pore volume in cc/g×10⁻³ by a KOH activated carbon material (activated for 2 h with KOH:carbon in a weight ratio of 4:1, at 700° C.) of this invention versus the pore diameter of the carbon material.

FIG. 7 is a graph showing the pore volume in cc/g×10⁻³ by a KOH activated carbon material (activated for 0.5 h with KOH:carbon in a weight ratio of 4:1, at 700° C.) of this invention versus the pore diameter of the carbon material.

FIG. 8 is a graph showing the specific capacities in F/g of samples of carbon materials prepared according to applicants' invention at NaOH/PPE-carbon ratios (w/w) of 0.75, 1.5, 2.3, 3.007 and 3.8.

FIG. 9 is a graph showing the weight gain (wt %) of carbon material of this invention vs. the temperature in ° C.

FIG. 10 is a graph showing the total carbon yield in weight % for four samples of carbon materials according to this invention with different oxidation temperatures in ° C.

FIG. 11 is a graph showing the ratio of poly(phenylene ether) to carbon fiber paper at different weight percentage concentrations of poly(phenylene ether) solutions for a carbon fiber paper sample made according to applicants' invention.

FIG. 12 is a graph showing the carbon yield in percent at different ratios of poly(phenylene ether) to carbon fiber paper for samples of carbon fiber paper made according to the process of applicants' invention.

FIG. 13 is a graph showing the thickness (mm) under nominal pressure of various ratios of poly(phenylene ether) to carbon fiber paper made according to the process of applicants' invention.

FIG. 14 is a graph of area density (g/m²) of various ratios of poly(phenylene ether) to carbon fiber paper made according to the process of applicants' invention.

FIG. 15 is a graph of apparent density in g/cm² of various ratios of poly(phenylene ether) to carbon fiber paper made according to the process of applicants' invention.

FIG. 16 is a graph of gas permeability in ml/s.cm².mmH₂O of various ratios of poly(phenylene ether) to a carbon fiber sample made according to the process of applicants' invention.

FIG. 17 is a graph of gas permeability in ml/s.cm².mmH₂O of various ratios of poly(phenylene ether) to another carbon fiber paper sample made according to the process of applicants' invention.

FIG. 18 is a graph of resistance in ohm/layer of ratios of poly(phenylene ether) to a carbon fiber paper sample made according to the process of applicants' invention.

FIG. 19 is a graph of electric conductivity in S/cm of various ratios of poly (phenylene oxide) to a carbon fiber paper made according to applicants' invention.

FIG. 20 is a graph of weight change in wt percent measured for a carbon material of applicants' invention at various oxidation temperatures in ° C.

FIG. 21 is a graph of carbon yields in weight percent for a carbon material made according to the process of applicants' invention taken at various oxidation temperatures.

The FIGs are meant to further illustrate the invention and not to limit the scope thereof.

### DETAILED DESCRIPTION OF THE INVENTION

The poly(phenylene ether) (PPE), also known as poly(phenylene oxide) (PPO), precursor used to make the modified poly(phenylene ether) of this invention has a chemical structure characterized by the following recurring unit:

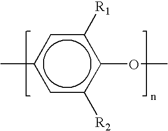

wherein R₁ and R₂ each are selected from the group consisting of hydrogen, aliphatic groups (e.g., C₁₋₆, preferably C₁₋₄), aromatic groups (e.g., C₆₋₂₄, preferably C₆₋₁₂), aliphatic ethers, aromatic ethers, aliphatic esters, aromatic esters, ketones, carboxylic acids, xanthones, lactones and carbonyl esters, wherein intermolecular and intramolecular linkages exist between the R1 and R2 groups and n is an integer between 10 and 10,000. Poly(phenylene ethers) in which R₁ and R₂ are H, methyl or ethyl groups are generally employed since they are the most prevalent material and are readily available commercially. As illustrated in the above formula, PPE has aromatic rings along the main chain and has a carbon content of about 80 wt %, when R₁ and R₂ are each methyl groups. With such properties, applicants have found that poly(phenylene ether) provides an excellent precursor material for polymeric carbon preparation.

Carbon yield of an unmodified poly(phenylene ether) is less than satisfactory, about 26 wt %. Applicants have now discovered that if poly(phenylene ether) is crosslinked in an oxidizing atmosphere, presumably air, for a preselected period of time before being carbonized, yield increases significantly from about 26 wt % to about 60 wt %. Both interchain and intrachain crosslinkings take place during the oxidization period. Crosslinking, oxidation and stabilization are essentially the same process and these terms will be referred to interchangeably throughout the specification herein. The formed substance (oxidized polymer), which is referred to as modified-PPE (MPPE), is brown in color instead of the yellowish white color of the original polymer. Applicants have found that when poly(phenylene ether) is so oxidized before being carbonized, the modified poly(phenylene ether) has a much higher glass transition temperature (>280° C.) than the glass transition temperature of the original PPE polymer. Glass transition of the heavily modified-PPE disappears because of the large amount of crosslinks that are formed during the stabilization process. Applicants have found that the MPPE does not soften or deform notably during the carbonization process. Applicants also have discovered that parameters of the process of making the carbon material of this invention significantly affect properties of the final product.

Further, applicants have discovered that the activation step in the process of making the carbon material also significantly modifies the properties of the carbon material of this invention.

The process of preparing the activated carbon powder includes three major steps; stabilization in an oxidizing atmosphere, carbonization in an inert atmosphere and activation by a proper activation agent.

The precursor polymer of such carbon powder is preferable in the form of polymer powder. If the precursor polymer is composed of relatively large bodies, such as pellets instead of powder, the precursor preferably should be ground into a fine powder sized between ⅛ and 400 mesh number, prior to the stabilization process to ensure that a uniformly crosslinked material will be formed. The polymer powder is oxidized in an oxygen-containing atmosphere, preferably air, at an elevated temperature between 50° C. and 450° C., preferably near the glass transition temperature of the material, for a time period (typically between 0.1 and 72 h) sufficient to crosslink the PPE polymer to form a modified-PPE, as defined hereinabove.

The modified-PPE powder then is transferred to a container that is in a non-oxidizing atmosphere including nitrogen, argon, helium or vacuum protection 10⁻¹⁰ torr to 10⁵ atm, preferably 0.1 torr to 500 atm, and heated to elevated temperatures ranging from 400° C. up to 3000° C., depending on the application. The heating rates are controlled between 0.1° C./min-40° C./min or higher.

Such non-activated MPPE based carbon material can have a high BET surface area of no less than 100 m²/g, which can be directly utilized in different applications without further activation.

Activated carbons have a high surface area and porosity. They are produced by two principal methods: physical and chemical activation. Physical activation involves heating a previously charred material at high temperature in the presence of an oxidizing gas, such as steam and CO₂. Chemical activation involves heating a mixture of the raw material and dehydrating and chemical agents from 200° C. to 1100° C. After carbonization, the agents are leached out and reused.

For steam activation, the aforementioned carbon powder is transferred to a furnace, preferably a rotary furnace, where a stream of steam/nitrogen mixture is flowed through the carbon powders. The molar ratio of steam/nitrogen ranges from 1:4 to 6:1. The activation temperature is set in the range of 500° C. to 1100° C., while the activation duration can be in the range of 0.5 h to 10 h. When activation time was increased, the specific surface area and corrosion of the PPE based carbon material increased. When treated at 900° C. for 2 h, a BET surface area of 1500 m²/g is obtained.

When activation is carried out with strong bases such as KOH or NaOH, a BET surface area greater than 4000 m²/g can be obtained. The non-activated carbon powder is first blended with KOH pellets or KOH solution with a KOH/carbon weight ratio of 1:10 to 12:1 (dry weight basis). If KOH solution is employed, subsequent drying is conducted to reduce the moisture content of the blend to about 25 wt %. If KOH pellets are employed, vigorous blending is used until the mixture is uniformly powdered. The mixture then is transferred to a container made of nickel or stainless steel and heated from 450° C. to 1100° C., under nitrogen protection, for 0.1 to 10 h. Following the activation process, water and acid solution is flushed through the carbon mixtures to clean the activated carbon material.

The pore size distribution of the product can be controlled so that it is very uniformly distributed in the micropore region; i.e., below 2 nm. Such pore size distribution can be manipulated by altering the activation time. The base/carbon weight ratio ranges from 1:10 up to 12:1 and higher. A higher weight ratio of base/carbon generally provides higher surface area.

The preparation of carbon/carbon fiber composite comprises three major steps: preparation of polymer/carbon fiber paper composite, stabilization in an oxidizing atmosphere, and carbonization in an inert atmosphere.

The procedure of fabricating carbon/carbon powder composite comprises three major steps: preparation of a polymer/carbon powder body, stabilization in oxidizing atmosphere and carbonization in an inert atmosphere.

Applicants have found that when the original poly(phenylene ether) carbonized and formed into carbon fiber paper, the formed carbon paper was wrinkled and warped. Applicants believe the wrinkling and warpage occurred because the PPE softens beyond 220° C. and, thus, deformed during the carbonization period. Applicants have found that the MPPE does not soften or deform notably during the carbonization process. As a consequence, the formed shape of PPE is maintained during the carbonization procedure without major deformations, such as rippling or cracking.

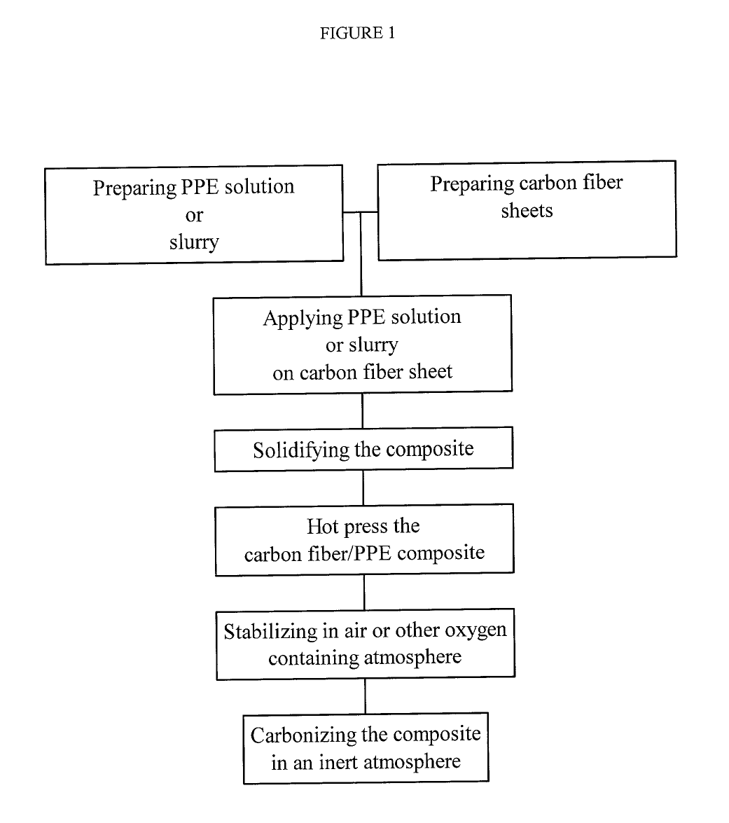

The general procedure of carbon/carbon composite fabrication is illustrated in FIG. 1. To prepare a used base carbon powder, fine particles of PPE are adopted as the precursor.

A solution of PPE is first prepared by dissolving PPE into a suitable solvent. Suitable solvents include methylene chloride, chloroform, toluene and other aromatic compounds and other halogenated compounds such as tetrachloroethylene and trichloroethylene. If necessary, carbon powders such as graphite powders, carbon blacks or activated carbon powders are also added to the solution to form a slurry to the solution mixture.

The concentration of the polymer solution ranges from 5 wt % up to 20 wt %, depending on the molecular weight of the precursor and the desired viscosity of the mixture. High molecular weight PPE generates higher viscosity solutions than lower molecular weight PPE at the same concentration. Adjustment of the polymer solution concentration can affect the properties of the final product significantly. If a porous body is desired, a low concentration solution should be selected. On the contrary, a highly concentrated solution is more suitable when high strength and high electric conductivity for the final carbon product are the major requisite.

To fabricate a carbon sheet, a piece of carbon fiber paper is cut into a desired shape. The PPE solution or the PPE slurry is then applied to the carbon fiber paper by casting, dipping or extruding. The formed composite, which is also referred to as the preform, then is dried in air either at room temperature or at elevated temperatures.

To fabricate a carbon/carbon powder composite, the aforementioned PPE solution is first mixed with a carbon powder, such as graphite or activated carbon powder. The formed slurry is then transferred to a mold with a desired shape. The preform is then dried at room temperature or at elevated temperatures to solidify the slurry.

To further reduce deformation during the carbonization process, the composite can be optionally pressed under high pressure from above about 10 psig to 5000 psig, preferably from above about 100 psig to 5000 psig, and most preferably from above about 1000 psig to 2000 psig. The composite is optionally pressed at a temperature higher than room temperature or elevated temperatures. The range of temperatures is preferably from above about 25° C. to 900° C., more preferably from above about 100 ° C. to 500° C., and most preferably from above about 200° C. to 300° C.

The pressed composite then is stabilized in air or other oxidizing atmospheres. The temperature is in the range of 150° C.-300° C. Temperature ramping or temperature steps can be employed for oxidization that is more efficient.

Carbonization is performed in an inert atmosphere including nitrogen, argon, helium, or vacuum protection. The heating rates are between 2° C./min and 40° C./min or higher. The final heat treatment temperature depends on the application, and ranges from 600° C. up to 2500° C.

Each aforementioned preparation parameter affects the properties of the carbon paper differently, as is discussed below.

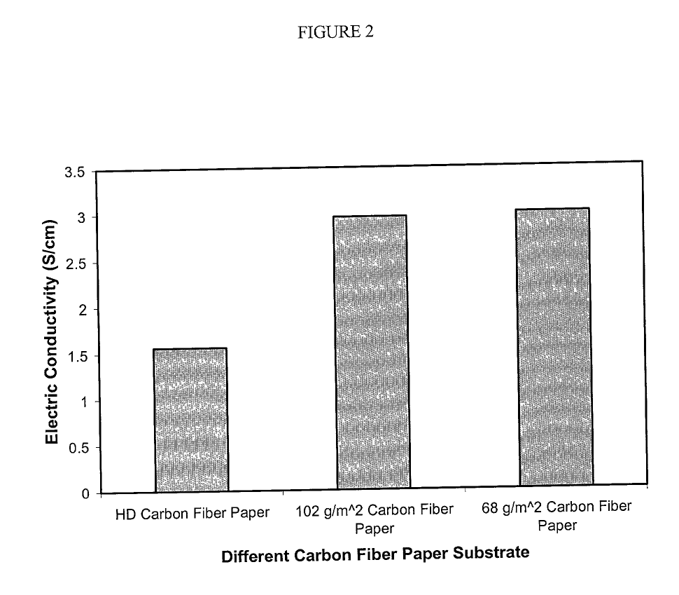

For the carbon/carbon fiber composites, the carbon fiber paper chosen as substrate for the PPE-carbon paper affects its performance. For example, when two types of carbon fiber paper both having an apparent density of 68 g/m² were compared: carbon fiber paper from Technical Fibre Products® and HD carbon fiber paper from Zoltek®, applicants found that different final carbon products formed because of the different proprietary methods by which these two carbon fiber papers are made. The carbon paper made with 68 g/m² carbon fiber paper had higher electric conductivity than the carbon paper made with HD carbon fiber paper (FIG. 2). Therefore, 68 g/m² carbon fiber paper was selected to fabricate an MPPE carbon paper. Other types of carbon fiber sheets may also be utilized to fabricate the PPE-carbon fiber paper.

In addition to commercially available carbon fiber sheets, customized carbon fiber sheets were also prepared. The procedure is a modified hand-sheet paper preparation procedure that can be readily adopted to industrial fabrication. A chopped carbon fiber was used as the precursor for making carbon fiber sheets. The carbon fibers were first mixed with large amounts of water, at a concentration of 0.01-5 wt %, preferably 0.2 wt %, for 68 g/m² carbon fiber sheet fabrication. Anionic, cationic or nonionic surfactants can be added to such a mixture to ensure good dispersion of the carbon fibers. Cellulose fibers then were added to the carbon fiber/water mixture. Intensive stirring, in the form of mechanical blending or ultrasonication, was applied to the mixture to ensure uniformity of the dispersion. The water then was drained rapidly, and a uniform carbon fiber sheet, with small amounts of cellulose fibers as binder, was formed.

Cellulose fibers can be replaced with other types of fibers, such as, poly(vinyl alcohol), phenolic resin, polyacrylonitrile, and other polymeric fibers as binders of the carbon fibers. It is preferable that the binder fiber selected has good carbon yield itself, which will increase final carbonization yield of the formed bodies.

The stabilization process involves heating PPE in an oxidizing atmosphere or in the presence of oxygen. During crosslinking, PPE gets oxidized and both intermolecular and intramolecular crosslinking take place. The crosslinked or stabilized PPE does not soften prior to degradation. As a consequence, the formed shape of the carbon paper preforms will not change during carbonization. At higher temperatures, the process is faster, indicated by quicker weight gain and weight loss. A temperature of 230° C. is preferred for most of the preparations because the glass transition temperature of PPE is in the range of 200° C.-240° C. and, thus, the preform will not deform during the stabilization process. Although the heat temperature is generally constant, varying the temperature or heating the sample at different temperatures for different durations can enhance the efficiency of such processes.

The stabilization temperature significantly affects the properties of the final product. For a given time of crosslinking, carbon yield generally increases with higher stabilization temperature. Density of the modified-PPE (MPPE) carbon paper also increases and, consequently, electric conductivity of the carbon paper also increases.

Carbon yield of the carbon sheet or formed body, according to applicants' invention, is the weight yield of the carbon preform before and after the carbonization. The weight of carbon fiber paper or other carbon substance is counted in both cases and, thus, the carbon yield is for the carbon sheet or other type of formed body, not the polymer.

Carbonization temperature and time are two important conditions that affect the performance of MPPE carbon sheets. With higher carbonization temperature, the electrical conductivity of MPPE carbon increases. As temperature increases, more and more oxygen and hydrogen are removed and the purity of the remaining carbon becomes more graphitic, increasing electrical conductivity. Conductivity increases slowly at temperatures up to 900° C., but above 1000° C., there is a sharp rise in conductivity.

When carbonization time was increased, electric conductivity of MPPE carbon also increased. Since elimination of impurities is a kinetic process and some species may be stable at the heat treatment temperature, the rate of conductivity incrementally decreases with time. Applicants found that the carbonization temperature had more effect on the properties of PPE-carbon paper than did the time of carbonization. Thus, Applicants discovered that the best way to improve the conductivity of PPE-carbon is to increase the carbonization temperature.

The addition of carbon powders is also conducted during the preparation of carbon sheets. The addition of carbon powders further enhances electric conductivity and eliminates warping of carbon paper, which may occur with some experimental conditions. The type of added carbon powders also will affect properties of the carbon paper. High surface area activated carbon powders will increase surface area of the carbon paper without further activation, while addition of graphite powder will increase electric conductivity.

Black Pearl® is a type of carbon black that has a high surface area and electrical conductivity. Carbon blacks are generally prepared by burning gaseous or liquid hydrocarbons in a limited supply of air at about 1000° C. Two chemical processes, incomplete combustion in air and thermal decomposition of a hydrocarbon source, are involved in the production of carbon blacks. The various stages involved in the manufacturing of carbon black are thermal decomposition or partial oxidation of hydrocarbons, formation of poly-aromatic macromolecules in a vapor phase followed by nucleation of these macromolecules into droplets, which are then converted into carbon-black particles.

When mixed with other types of carbon powders, including PPE-carbon (i.e., carbon made up from PPE) powders that give nucleation sites, an increase in the overall carbon yield of the PPE-carbon paper is observed. As a result of an increase in the carbon yield, the density and the electric conductivity of carbon paper also improves.

Graphite powders have high electrical conductivity and smaller surface area and are produced by heat treating carbon at 2500° C. to 3000° C. Mixing graphite powders with PPE is another way to improve the conductivity of PPE-carbon paper. As the percentage of graphite powder increases, the density and the electrical conductivity of PPE-carbon paper also improves.

Carbon paper is a porous material. Specific surface area is one of the important properties that affect performance of PPE-carbon paper. Different post-treatment conditions affect the performance of PPE carbon paper. Activation is used to make activated carbon, which increases the specific surface area of PPE carbon paper.

If activation is desired, the formed carbon/carbon fiber composite or carbon/carbon powder composite can be further activated with steam, LiOH, NaOH, KOH, H₂SO₄, CO₂, and oxygen or air at elevated temperatures.

For steam activation, when activation time was increased, the specific surface area and corrosion of the PPE-carbon paper increased. There was a sharp increase in the specific surface area for the first hour followed by a relatively slow increase thereafter. The surface activation rate was found to be higher than that of the internal part of the carbon paper.

When activation is carried out with strong bases such as KOH or NaOH, an activated carbon material having a surface area of greater than 4000 m²/g can be obtained. The pore size distribution of the product is very uniformly distributed in the micropore region; i.e., below 2 nm. The base/carbon weight ratio ranges from 1:2 up to 4:1; and the higher ratio provides better results.

The conductivity of all these carbon materials and carbon/carbon composites are high, which lends themselves to application in double layer capacitors, fuel cell electrodes and conductive paper.

Several techniques were employed to characterize properties of the carbon paper. Electric conductivity and gas permeability are the most important properties for fuel cell application of carbon paper.

The single layer resistance, s, (cm²) of carbon paper depends both on the electric conductivity and the thickness of the carbon paper.

$$R = ρ \cdot \frac{l}{s}$$

where R (ohm) is resistance of the sample, l (cm) is the thickness of the sample, s (cm²) is the geometrical area of the sample that contacts the current collectors, and ρ (ohm cm) is electric resistivity of the sample.

Based on the equation, the single layer resistance of the carbon paper depends on the area of the carbon paper sample. To compensate the size effect, the resistance is normalized to 1 cm². The resistance reported here is, thus, the area resistance (Ω/cm²) that does not depend on the geometric area of the test sample. Both the single layer area resistance and electric conductivity (s/cm), which is 1/ρ, are reported here, since the fuel cell and other electrical applications, single layer resistance directly reflects how well the carbon paper will perform, while the electric conductivity reflects the inherent electrical conductive property of the carbon paper.

The PPE based carbon paper reported here is a porous material. For applications such as fuel cell gas diffusion electrode or other energy storage applications, gas permeability is important. Gas permeability directly evaluates the difficulty for a gas to penetrate through a single layer of the carbon paper.

Under relatively low pressure and low flow rate, the equation below is applicable:

F=P·A·Pb

Where F (ml/sec) is the flow rate of the test gas; P is the pressure difference (cm water) of the gas applied across the carbon paper; A (cm²) is the geometrical area of the carbon paper; and Pb (ml/cm² sec cmH₂O) is the gas permeability of the carbon paper.

The gas permeability measured above depends on the thickness of the carbon paper. To characterize the intrinsic gas permeability, the thickness of the carbon paper must be normalized as follows:

$$[ Pb ] = \frac{F \cdot l}{P \cdot A}$$

where l is the thickness of the carbon paper.

The intrinsic permeability of the carbon paper does not depend on the thickness of the carbon paper; it depends solely on the structure and morphology of the carbon paper.

The following examples illustrate the Applicants' invention, but should not be construed as limiting the invention:

### EXAMPLES

### Example 1

A fine powder of PPE with a unit formula,

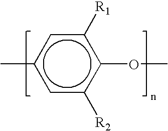

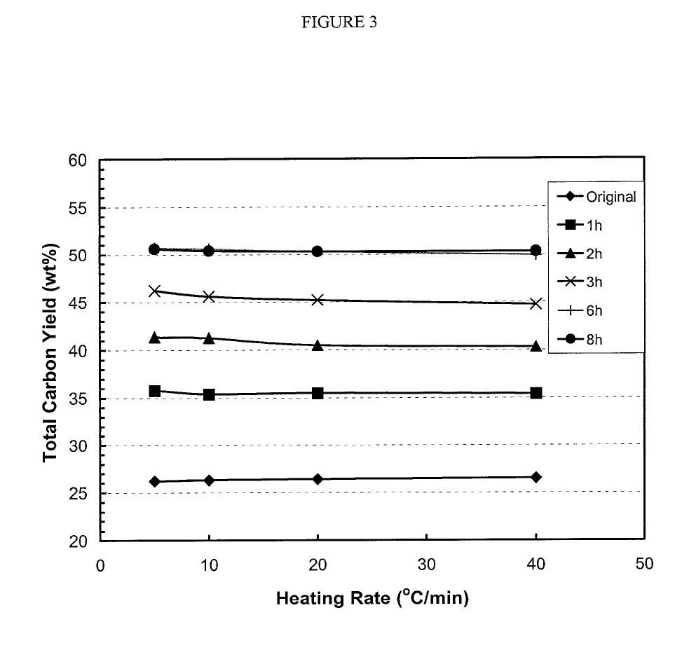

was employed directly to prepare carbon powders. The PPE powder first was oxidized at 230° C. for different durations ranging from 1 h to 8 h in air to form a modified-PPE (MPPE). The modified-PPE powder with a matrix that contains the functional section shown in Table 1, was then carbonized at various heating rates from 5° C./min up to 40° C./min under nitrogen protection. The MPPE carbonization temperature was 700° C., and the whole carbonization procedure was conducted under nitrogen protection. The final carbon yields obtained are shown in FIG. 3. Such carbon material had a high surface area (>500 m²/g) before any chemical or steam activation and the BET surface area was not affected by the oxidation duration as shown in Table 2 below.

TABLE 1

| Structure | % C | % H | % O |
|---|---|---|---|
| 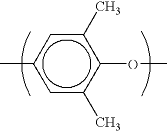 | 80.00 | 6.66 | 13.33 |
| 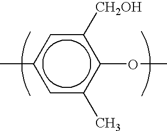 | 70.59 | 5.80 | 23.53 |
| 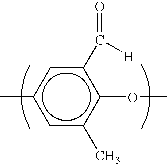 | 71.64 | 4.48 | 23.88 |
| 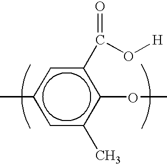 | 64.00 | 4.00 | 32.00 |
| 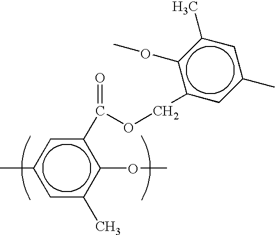 | 71.64 | 4.48 | 23.88 |
| 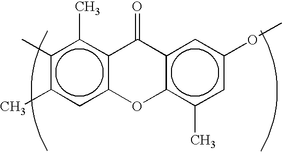 | 76.19 | 4.76 | 19.05 |

TABLE 2

| Oxidation Time (h) | BET* Surface Area (m²/g) |
|---|---|
| 0 | 523 |
| 1 | 500 |
| 2 | 504 |
| 3 | 511 |
| 6 | 528 |

*measured with N₂ (nitrogen)

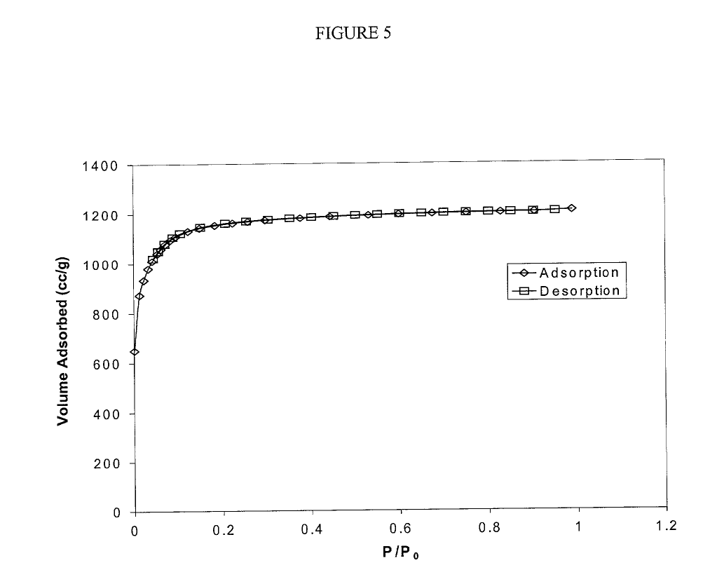

In addition to having a high surface area, such carbon material was microporous with a pore size distribution mainly in the micropore (diameter<2 nm) region as shown in FIG. 5.

### Example 2

The same procedures as those in Example 1 were followed. After the carbonization, the carbon powder was heated at 900° C., under a stream of mixed steam/N₂ with a molar ratio of 1:1. The activation was conducted for 2 h. The resultant activated MPPE carbon had a BET specific surface area of greater than 1100 m²/g. Similarly, when the carbon powder was heated at 700° C. for 5 h with steam/N₂ 1:1 (molar ratio), the resultant activated MPPE carbon had a BET surface area of greater than 800 m²/g.

### Example 3

The carbons prepared following the procedures of Example 2 were tested in a waste water treatment. Water containing trace amount of organic compounds, such as phenol and tricholorophenol, was stirred with the activated carbons and the amount of organic compounds adsorbed was measured and is set forth in Tables 3 and 4 below:

TABLE 3

| | Adsorbed phenol | Adsorbed phenol |
|---|---|---|
| Bulk concentration of phenol | by PPE 700 | by PPE 900 |
| aqueous solution (mmol/l) | (mmol/g) | (mmol/g) |
| 0.25 | 1.22 | 2.04 |
| 0.50 | 1.39 | 2.19 |
| 0.75 | 1.47 | 2.25 |
| 1.00 | 1.51 | 2.28 |
| 1.25 | 1.55 | 2.31 |
| 1.50 | 1.58 | 2.31 |

PPE-700 = MPPE carbon activated at 700° C.
PPE-900 = MPPE carbon activated at 900° C.

TABLE 4

| Bulk concentration | Adsorbed | Adsorbed |
|---|---|---|
| of trichlorophenol | trichlorophenol by | trichlorophenol by |
| aqueous solution (mmol/l) | PPE 700 (mmol/g) | PPE 900 (mmol/g) |
| 0.25 | 0.62 | 2.99 |
| 0.50 | 0.64 | 3.09 |
| 0.75 | 0.66 | 3.13 |
| 1.00 | 0.66 | 3.15 |

### Example 4

The procedures of Example 1 were followed to prepare a MPPE carbon powder which was then chemically activated. KOH pellets were mixed with the MPPE carbon powder directly. The amount of the KOH ranged from 1:2 up to 4:1 KOH/carbon weight ratio. Such mixture then was ground into a uniform mixture of fine particles.

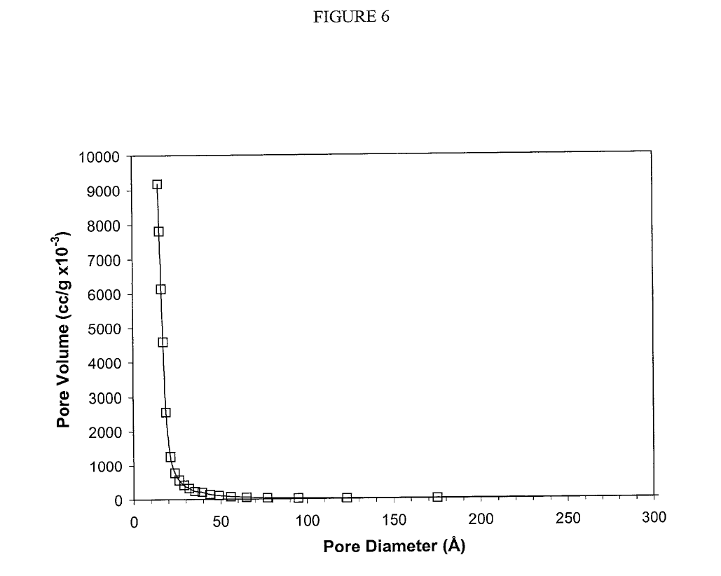

The mixture then was heated at an elevated temperature of 700° C. for 2 h, under nitrogen protection. The resultant mixture was further rinsed with de-ionized water. 1M HCl solution was utilized to exchange the potassium ions coupled with surface groups on the activated carbon. A final pH of ˜5 was achieved during the rinse before the activated MPPE carbon was dried at room or elevated temperature. Based on the nitrogen adsorption/desorption isotherms (FIG. 5), the BET specific surface area of such prepared carbon was up to about 4500 m²/g, while the pore size was uniformly distributed in the micropore region; i.e., <2 nm (FIG. 6). The BET specific surface area of the KOH activated PPE carbon powder is listed in Table 5 below:

TABLE 5

| KOH/carbon ratio | BET specific surface area (m²/g) |
|---|---|
| 1:2 | 780 |
| 1:1 | 971 |
| 2:1 | 1780 |
| 4:1 | 4442 |

### Example 5

The procedure of Example 3 was followed except that the KOH:carbon weight ratio was 4:1 and the activation was conducted for 0.5 h.

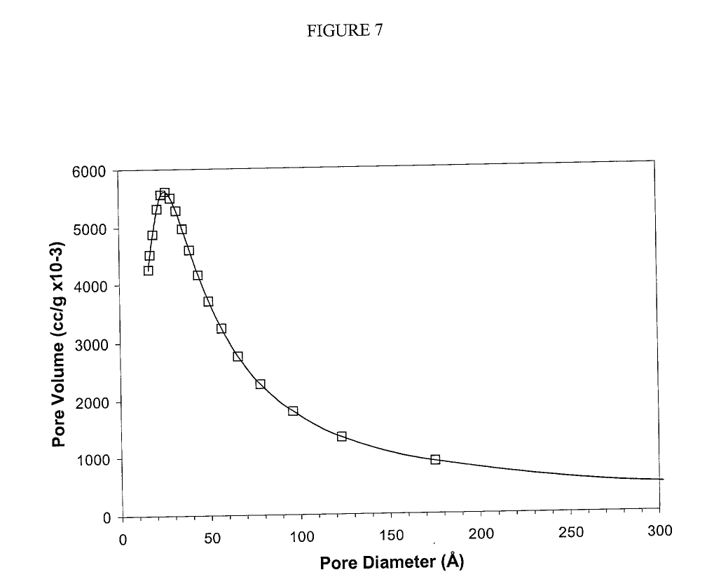

The activation carbon thus prepared yielded a BET surface area of 2673 m²/g. The pore size distribution of this activated carbon was different from the activated carbons in Example 3 (FIG. 7). This example illustrates that altering the treatment time can be used to control the pore size distribution of the KOH activated carbons.

### Example 6

The procedures of Examples 2 and 3 were followed to prepare the MPPE carbon powder as a precursor for this example. The steam activated carbon was put into an environment where the relative vapor pressure (P/P₀) of the selected organic compound was set at 0.8 (P: vapor pressure of the organic compound, P₀: atmosphere pressure). The volumes of the adsorbed organic compound on the activated carbon are listed Table 6 below. The data show that the activated carbons effectively adsorb organic compounds in the air.

TABLE 6

Adsorbed Volume (cm³/g), (%)*

| Carbon | Nitrogen | Benzene | Cyclohexane |
|---|---|---|---|
| MPPE-700 | 0.300 (100) | 0.26 (90) | 0.11 (38) |
| MPPE-900 | 0.563 (100) | 0.47 (84) | 0.33 (59)** |

*Compared to the volume filled with nitrogen

### Example 7

The procedure of Example 1 was followed to prepare a PPE powder, except that the PPE powder was stabilized at 230° C. for 6 h in air and the carbonization was performed at 700° C. for 2 h. The obtained carbon powder then was mixed with 9M NaOH solution. The formed slurry then was dried at elevated temperatures below the boiling point of the slurry, under N₂ protection. The NaOH/PPE carbon weight ratio ranges from 0.75 to 4. The solidified mixture then was heated at 500° C. for 2 h, under nitrogen protection. Following the activation process, the mixture was flushed with de-ionized water until a pH of about 7 was reached.

### Example 8

A NaOH activated MPPE carbon prepared following Example 6, was used as a precursor in this example. 8 wt % PPE chloroform solution was mixed with the aforementioned activated MPPE carbon powder. The formed slurry then was transferred into holes or dents on a Teflon® mold. The holes or dents were circular with an area of 1 cm² and 1 mm subterranean. The mold then was pressed at a pressure of 5000 psig, a temperature of 230° C., for 2 h to solidify the slurry. With such a process, carbon/PPE composites were obtained in the form of circular pellets that were 1 mm thick with an apparent surface area of 1 cm². These pellets were stabilized at 230° C. in air for 6 h. Carbonization of the composites was performed at 700° C. for 2 h, under nitrogen protection.

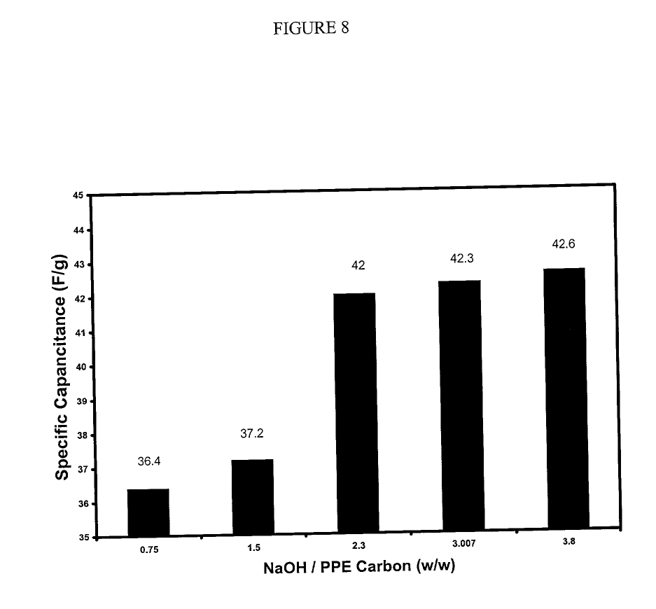

The formed carbon pellets were used directly as electrodes for double layer capacitors. Two pellets are stacked together with a piece of filter paper between them. The filter paper acted as a separator, which was a good ionic conductor but an electric insulator. Other separators include organic or inorganic material with good ion conductivity and high electric resistance, such as cellulose, ion-exchange membranes, porous polyvinylidene fluoride (PVF2) membranes, porous polypropylene (PP) membranes, porous ceramic membranes and combinations thereof. Two pieces of nickel net were employed as current collectors and placed adjacent to the two carbon electrodes individually. This whole assembly is encapsulated in a Teflon® container with both of the nickel nets connected to the outer circuit. 9M KOH water solution was used as the electrolyte. The carbon pellets and the filter paper were soaked in the solution. The capacitance of such a fabricated double layer capacitor is shown in FIG. 8. The capacitance was calculated based on discharging from 0.9 V to 0.5 V with a load of 100 ohms.

### Example 9

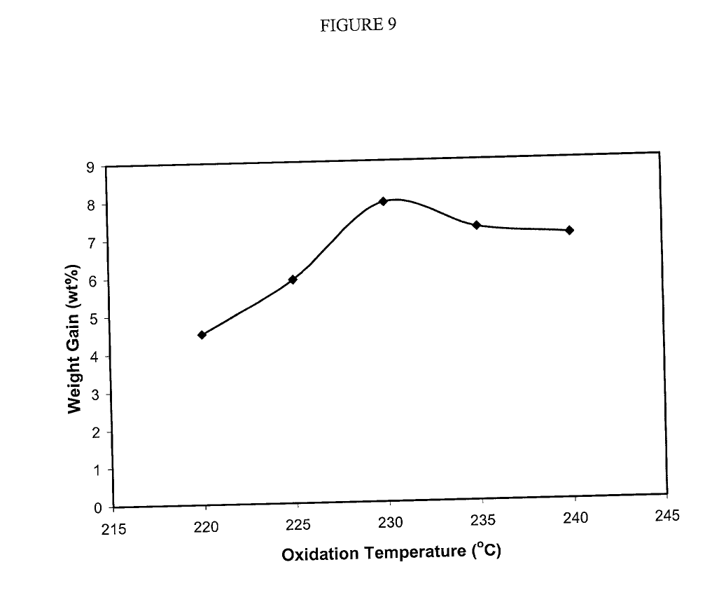

An 8 wt % PPE chloroform solution was prepared. Specifically, 16 gm PPE powder was dissolved into 84 gm chloroform, which was obtained from Fisher Scientific®. It was applied to 68 g/m² carbon fiber paper by casting. The preform then was dried in air at room temperature followed by further drying in a 70° C. oven overnight. It was pressed at 4000 psig for 1 h at 235° C. The thoroughly dried polymer/carbon fiber composite then was heated at elevated temperatures ranging from 220 to 240° C. for 12 h. The weight change of the preform during the process is listed in FIG. 9. The maximum weight gain occurred at 230° C., while higher temperatures led to lower weight gain above 230° C.

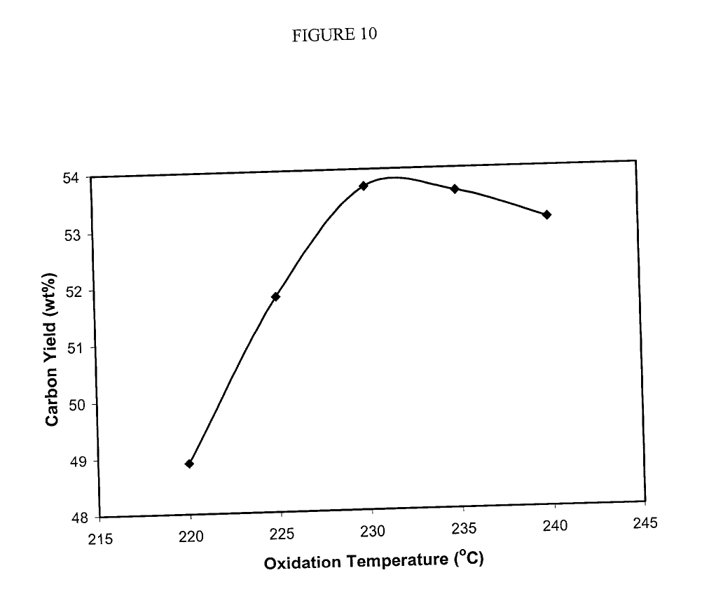

After the stabilization, the preform then was carbonized at 700° C. for 2 h with a heating rate of 10° C./min, the carbon yield of the carbon paper had a similar trend as did the weight change during the oxidation (FIG. 10). The carbon paper oxidized at 230° C. had the highest carbon yield, while the lowest yield was of the carbon paper oxidized at 220° C. The carbon yield increased sharply from 220 to 230° C. and then leveled off above 230° C.

### Example 10

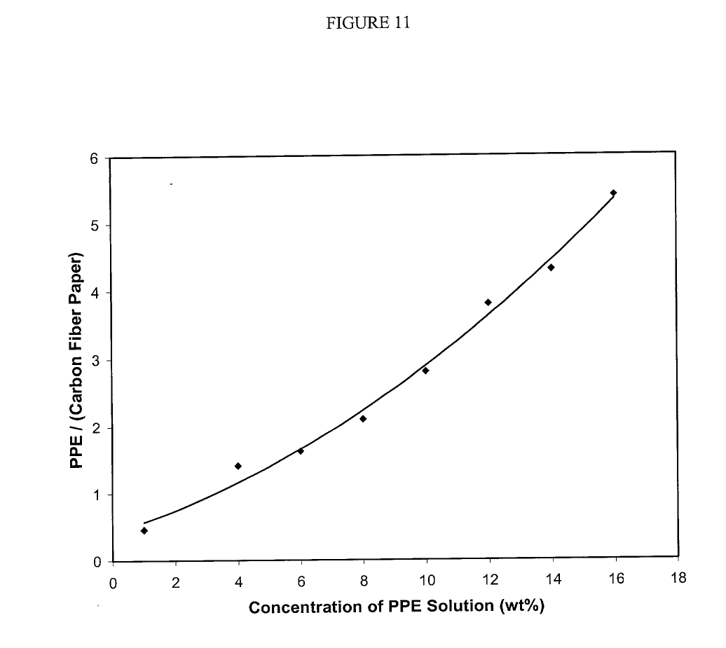

A series of PPE chloroform solutions were prepared ranging from 8 wt % up to 16 wt %. 34 g/m² carbon fiber paper was employed as a substrate and cut into 6″×6″sheets. The solution was cast onto the carbon fiber paper and then dried in air at room temperature before it was transferred to a 70° C. oven overnight. The composites prepared from each solution had different polymer/carbon fiber weight ratios, which are listed in FIG. 11. The polymer/carbon fiber ratios ranged from ½ for 1 wt % solution up to 5.5/1 for 16 wt % solution. Since the area density of the carbon fiber paper was the same, 34 g/m², the polymer content of the formed composite increased with more concentrated solutions.

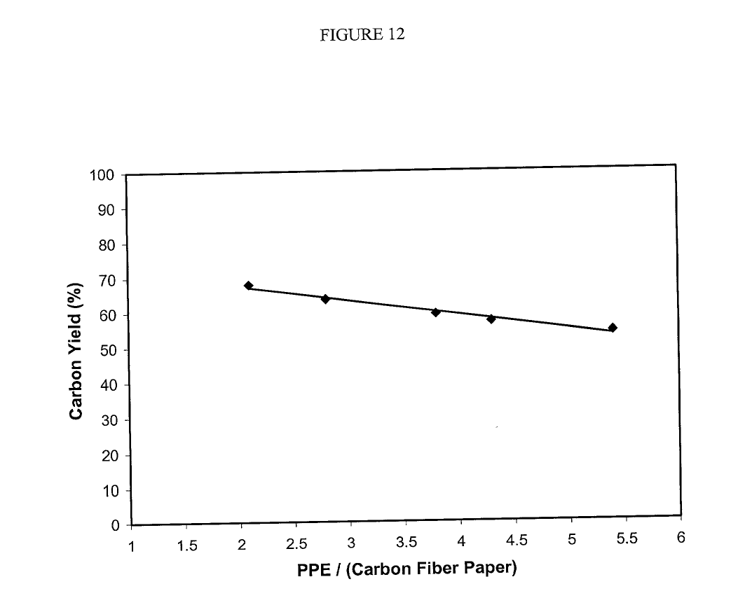

The preform then was carbonized at 900° C. for 30 min under N₂ protection. Since the carbon fibers in the carbon fabrics were prepared at ˜900° C., its weight loss during the carbonization was minimal compared to PPE during the carbonization process. With higher PPE content in the preform, the carbon yield of the carbon paper decreased from ˜68 wt % to as low as ˜52 wt %, as shown in FIG. 12. Such carbon yield did not reflect the carbon content of the carbon paper, low carbon yield did not indicate low carbon content in the carbon paper.

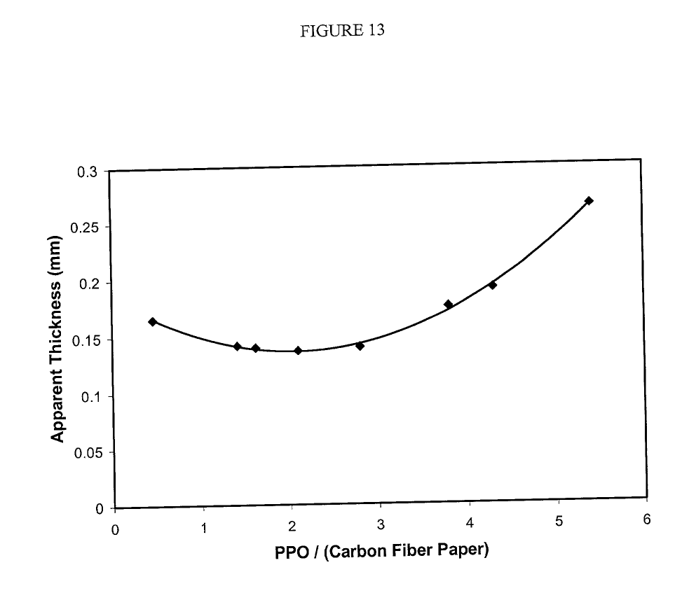

As stated previously, PPE-carbon paper is flexible. Thus, the thickness was dependent on the pressure applied on the carbon paper during the measurement. As shown in FIG. 13, the thickness measured at minimal contact pressure (apparent thickness) differed significantly from those measured under 30 psig. For the apparent thickness, the carbon paper with a PPE/carbon fiber ratio of 2 had the lowest value. Further lowering the PPE/carbon fiber ratio slightly increased the apparent thickness. This indicated that the carbon fibers expanded during the carbonization process, if there was not enough carbon binder, as in the case of carbon paper with a low PPE/carbon fiber ratio. Such expansion led to thicker carbon paper, but the whole structure was very loose. Once pressurized at 30 psig, these carbon papers could be compressed to 1/7^{th} of their apparent thickness, and a semi-linear relationship of pressed thickness and PPE/carbon fiber ratio was observed. Because of the hot press, the thickness of the carbon paper extended from ˜0.08 to ˜0.15 mm, which increased by a factor of ˜1.87, while the polymer/carbon fiber ratio of composites increased from 2.5 to 5.5 by a factor of ˜2.2.

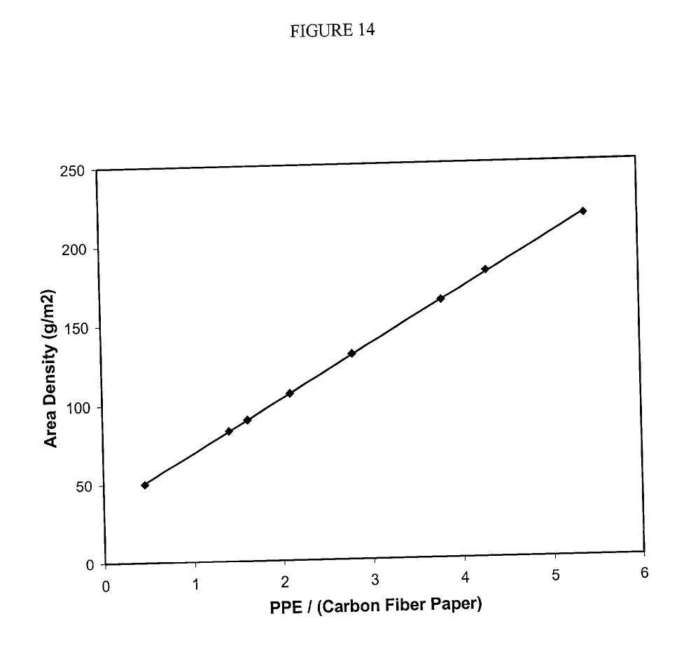

The area density indicated how much carbon was contained in a certain area of carbon paper. Thus, it was independent of the thickness of carbon paper during the measurement. Since the area density of the carbon fiber paper was constant, the area density was proportional to the PPE/carbon fiber ratio, as shown in FIG. 14.

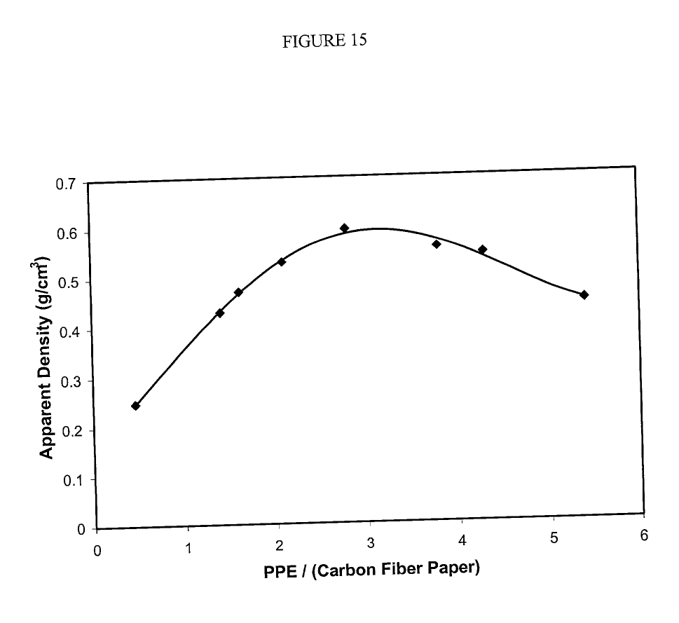

To correctly measure the bulk density of the carbon paper, the thickness of the carbon paper was identified. As discussed above, the thickness of the carbon paper depended on the pressure during the measurement. The apparent density measured with nominal pressure varied extensively with different carbon content (FIG. 15). The highest density appeared at a PPE/carbon fiber ratio of 3.

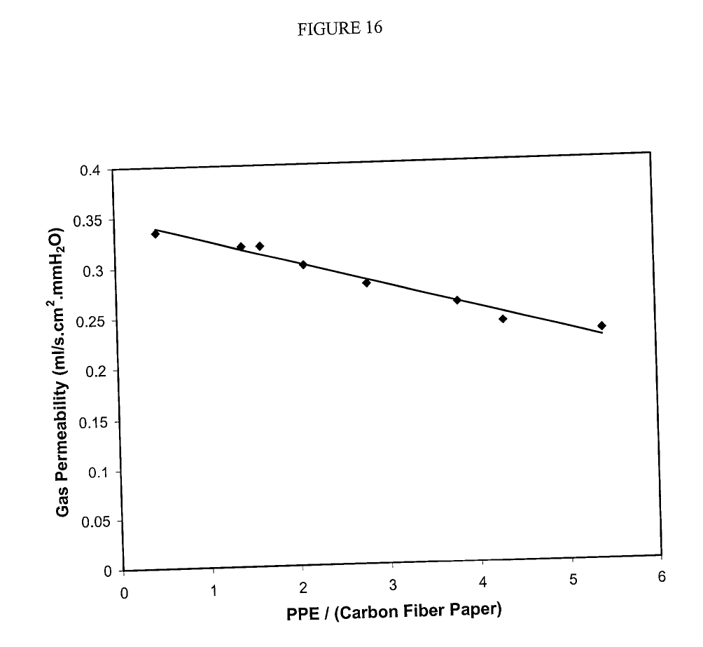

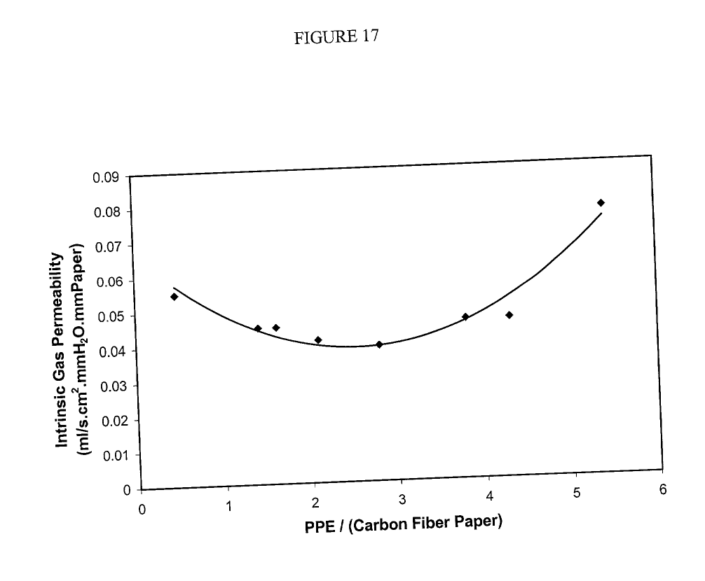

The gas permeability of a single layer carbon paper was measured under low gas pressure. Nitrogen was employed as the test gas for the measurement. As shown in FIG. 16, the gas permeability decreased with the polymer/carbon fiber ratio. This linear relationship could be readily compared to the area density (FIG. 14). Carbon paper with higher area density had higher carbon content and, thus, lower gas permeability for a specific geometrical sample area. Intrinsic gas permeability was introduced to characterize how easy the gas penetrated through the carbon paper material, which was independent of the carbon paper thickness, as discussed above (FIG. 17). Carbon paper with the highest density, the sample with a polymer/carbon fiber ratio of 3, had the lowest intrinsic gas permeability.

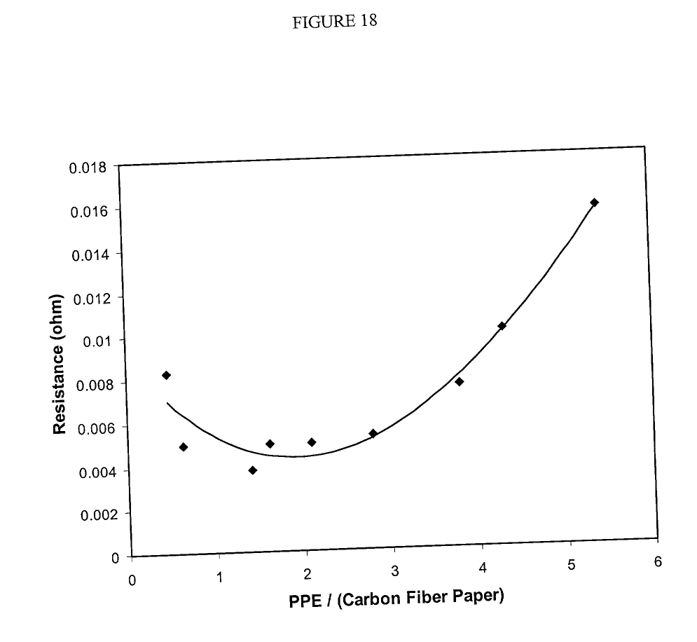

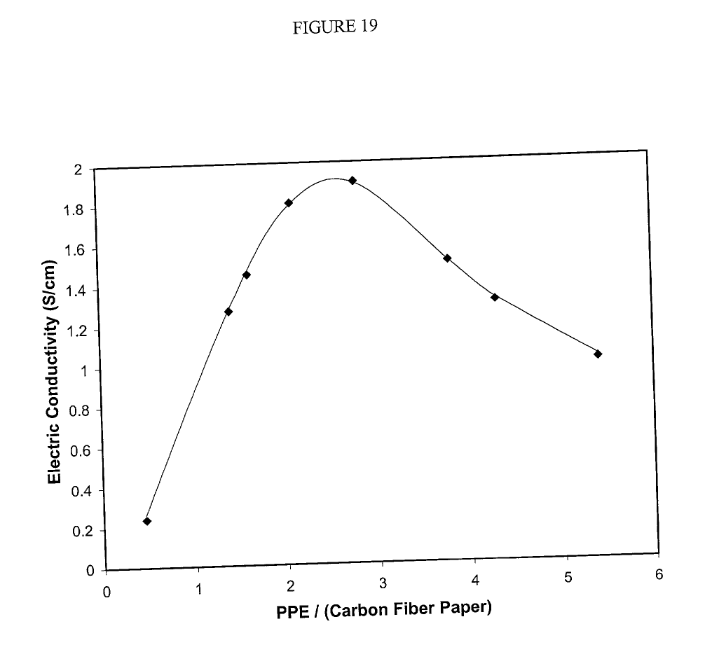

The single layer electric resistance of the carbon paper was measured with a high sensitivity multimeter KEILTHLEY® 177 DMM. The measurements were conducted under the pressure of 30 psig to ensure good contact and high reproducibility. A minimum resistance of 0.004 Ω/layer was observed for carbon paper with a PPE/carbon fiber ratio of 1-2 (FIG. 18). The carbon paper with lower polymer/carbon fiber ratios had higher resistance because of the low carbon content, while the thickness of the carbon paper increased with polymer/carbon fiber ratios, which resulted in higher electric resistance. This trend of resistance was similar to that of the intrinsic gas permeability discussed above. Conductivity, on the other hand, did not depend on the thickness of the carbon paper (FIG. 19). Since the bulk density was similar under 30 psig for all the carbon papers, conductivity depended mainly on area density, as the similar tendencies indicated.

### Example 11

An 8 wt % PPE chloroform solution was prepared. Specifically, 16 gm PPE powder was dissolved intro 184 gm chloroform, which was obtained from Fisher Scientific®. It was applied to 68 g/m² carbon fiber paper by casting. The preform then was dried in air at room temperature followed by further drying in a 70° C. oven overnight.

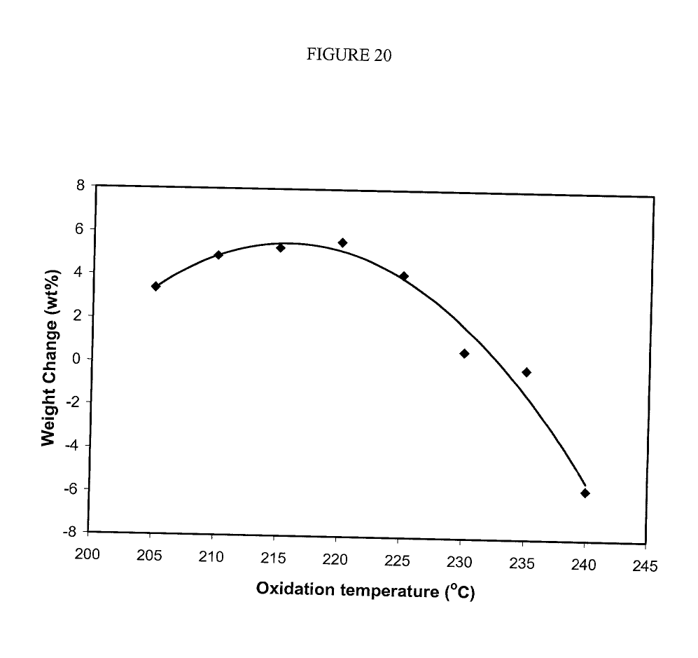

The thoroughly dried polymer/carbon fiber composite then was heated at elevated temperatures ranging from 205 to 240° C. It was first oxidized at a designated temperature for 6 h, and then the temperature was increased by 20° C. for another 12 h. The weight change of the preform during the process is listed in FIG. 20. The maximum weight gain occurred between 215° C. and 220° C., while higher temperatures led to lower weight gain or even weight loss which was experienced above 230° C.

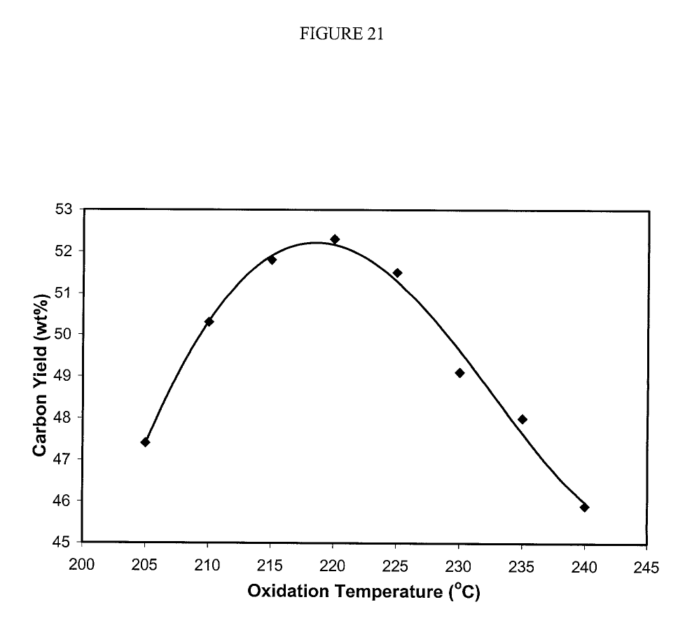

After the stabilization, the preform then was carbonized at 700° C. for 2 h with a heating rate of 10° C./min. The carbon yield of the carbon paper had a similar trend as the weight change during the oxidation (FIG. 21). The carbon paper oxidized at 220° C. had the highest carbon yield, while the lowest carbon yield was of carbon paper oxidized at 240° C.

### Example 12

The process of Example 11 was repeated. The carbon paper formed was used as a precursor for this example. The carbon paper was heated at 700° C., under a stream of steam/nitrogen mixture. The mixture gas was composed of steam and nitrogen with a molar ratio of 1:1. The duration of such activation ranges from 1 to 5 h. BET specific surface area of the activated MPPE carbon paper is shown in Table 7 below:

TABLE 7

| Activation Time (h) | BET specific surface area (m2/g) |
|---|---|
| 0 | 140 |
| 1 | 394 |
| 3 | 436 |
| 5 | 452 |

### Example 13

Similar to Example 8, the PPE/carbon fiber preform was stabilized in air at 230° C. for 6 h. The carbonization then was carried out at different temperatures ranging from 750 to 1100° C. The electric conductivity of the obtained carbon sheets is listed in Table 8 below:

TABLE 8

| Carbonization Temperature (° C.) | Electric Conductivity (S/cm) |
|---|---|
| 750 | 1.8 |
| 900 | 4 |
| 1000 | 6.5 |
| 1100 | 12.4 |

### Example 14

As in Example 8, the PPE/carbon fiber preform was stabilized in air at 230° C. for 6 h. The carbonization process was conducted at 700° C. for different durations. The electric conductivity of the carbon sheets is shown in Table 9 below:

TABLE 9

| Carbonization Time (min) | Electric Conductivity (S/cm) |
|---|---|
| 30 | 1.2 |
| 45 | 1.3 |
| 60 | 1.4 |
| 90 | 1.5 |

### Example 15

The same procedures as Example 8 were followed, except that a slurry of PPE/Black Pearl® 2/chloroform, instead of pure PPE/chloroform solution, was applied to the carbon fiber paper. The content of Black Pearl® refers to Black Pearl® weight percent in the total solid content of the slurry. The electric conductivity of the consequent product is listed in Table 10 below:

TABLE 10

| Content of Black Pearl ® (wt %) | Electric Conductivity (S/cm) |
|---|---|
| 14.3 | 1.4 |
| 23.1 | 1.5 |
| 32.1 | 1.8 |
| 51.4 | 2.5 |

### Example 16

Instead of using Black Pearl® to form the slurry, as in Example 10, graphite powder was used. The rest of the preparation was the same as Example 10. The electric conductivity of the resultant product is listed in Table 11 below:

TABLE 11

| Content of graphite powder (wt %) | Electric Conductivity (S/cm) |
|---|---|
| 0 | 0.6 |
| 5 | 1.6 |
| 7 | 2.2 |
| 10 | 3.1 |

### Example 17

The same procedures as in Example 7 were followed and the carbon pellet was used as the anode for lithium-ion battery. The cathode was fabricated from LiCoO₂ powder with polytetrafluoroethylene as the binder. A similar structure to the double layer capacitor was employed where a similar separator was sandwiched between the cathode and anode. The electrolyte was a 1M lithium tetrafluoroborate in propylene carbonate (PC). A capacity of about 300 mAh/g was achieved.

It should be understood that while the present invention has been described in detail with respect to certain illustrative and specific embodiments thereof, it should not be considered limited to such but may be used in other ways without departing from the spirit of the invention and the scope of the appended claims.

What is claimed is:

1. A carbon material carbonized/prepared from a poly(phenylene ether), wherein the carbon material comprises a porosity from 10-90%; a maximum pore diameter from 0.00015 to 500 micrometers (μm); a BET surface area prior to activation between 100 m²/g and 700 m²/g; and 60-99.99 weight percent of carbon.

2. A composite comprising a carbon and a modified poly(phenylene ether) carbon material, wherein said carbon material comprises a porosity from 10-90%; a maximum pore diameter from 0.00015 to 500 micrometers (μm); a BET surface area prior to activation between 500 m²/g and 4200 m²/g; and 60-99.99 weight percent of carbon, wherein the carbon material binds carbon particles and/or carbon fibers while maintaining the shape of the composite.

3. A method of preparing an activated carbon from a poly(phenylene ether) precursor polymer having a chemical structure characterized by the following recurring unit: 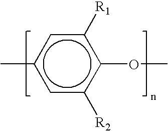
wherein R₁ and R₂ are each the same or different and are selected from the group consisting of a hydrogen, a C₁-₆ aliphatic group, a C₆-₂₄ aromatic group, an aliphatic ether, an aromatic ether, an aliphatic or aromatic ester, a carbonyl ester, a carboxylic acid, a ketone, a lactone, and a xanthone; wherein intermolecular and intramolecular linkages exist between the R₁ and R₂ groups in the modified poly(phenylene ether); and n is an integer between 10 and 10,000, the method comprising:
a) oxidizing the poly(phenylene ether) precursor polymer in an oxidizing atmosphere at an elevated temperature between 50° C. and 450° C. for a time period sufficient to crosslink the PPE polymer to form a modified poly(phenylene ether) as defined hereinabove; and
b) carbonizing the modified poly(phenylene ether) at a temperature between 400° C. and 3000° C. in a non-oxidizing atmosphere for a time period sufficient to form a carbon powder material having a BET surface area before activation between 500 m²/g and 700 m²/g and comprising 60-99.99 weight percent carbon.

4. The method according to claim 3 further comprising:
a) mixing the carbon powder material with an alkali metal hydroxide pellet(s), powder, or solution in an alkali metal hydroxide to carbon activated powder weight ratio of 1:10 to 12:1 on a dry weight basis;
b) transferring the mixture to a container made of nickel, stainless steel or other oxidation resistant material and heating said mixture from 450° C. to 1100° C. under nitrogen protection or other inert atmosphere for 0.1 to 10 h; and
c) flushing water and acid solution through the carbon mixtures to clean the activated carbon material.

5. The method according to claim 3 further comprising:
a) oxidizing the precursor polymer in an oxidizing atmosphere at an elevated temperature between 50° C. and 450° C. for a time period sufficient to crosslink the poly(phenylene ether) polymer to form a modified poly(phenylene ether), as defined hereinabove; and
b) carbonizing the modified poly(phenylene ether) at a temperature between 400° C. and 3000° C. in a non-oxidizing atmosphere for a time period sufficient to form carbon powder material having a BET surface area before activation between 500 m²/g and 700 m²/g and comprising 60-99.99 weight percent carbon.
c) transferring the carbon powder to a furnace where a stream of a steam and nitrogen mixture comprising a molar ratio ranging from 1:4 to 6:1 is passed through; and
d) activating the carbon powder at elevated temperatures ranging from 300 to 1100° C. for 0.1 to 10 h.

6. The method according to claim 3, further comprising the step of activating said carbon/MPPE carbon composite with one selected from the group comprising oxidizing gases, bases, or acids, at elevated temperatures.

7. A method of preparing a carbon/carbon composite from a modified poly(phenylene ether), the method comprises:
a) forming a carbon fiber fabric with an organic fibrous binder selected from the group consisting of cellulose, cellulose ethers, cellulose ether derivatives, polyacrylonitrile, oxidized polyacrylonitrile, phenolic resins, polyvinyl acetate, epoxides, and combinations thereof;
b) forming a solution of poly(phenylene ether) or a slurry from mixing the poly(phenylene ether) solution with other carbonous materials;
c) applying said poly(phenylene ether) solution to said carbon fiber fabric to form a composite;
d) drying the thus-formed composite;
e) pressing said dried composite under a pressure between 1 and 10,000 psig;
f) oxidizing said pressed composite in an oxygen containing atmosphere at elevated temperatures between 100° C. and 420° C. for a time period sufficient to crosslink the poly(phenylene ether) polymer to form a modified poly(phenylene ether) as defined herein above;
g) carbonizing the modified poly(phenylene ether) at a temperature between 500° C. and 3000° C. in a non-oxidizing atmosphere for a time period sufficient to form a carbon material comprising 60-99.99 weight percent carbon, wherein said carbon material is a modified-PPE electrode; and
h) activating said modified poly(phenylene ether) electrode with one selected from the group comprising oxidizing gases, bases, or acids, at elevated temperatures.

8. The method according to claim 7 further comprising the step of activating said modified poly(phenylene ether) carbon material with one selected from the group comprising oxidizing gases, bases or acids at elevated temperatures.

9. A method for making porous electrodes for double layer capacitors comprising:
a) forming a slurry from mixing a poly(phenylene ether) solution with other carbonous materials;
b) transferring said slurry into a body having holes or dents on it;
c) drying the slurry at room or elevated temperatures to form a solid body;
d) pressing the thus-formed solid body at a high pressure from about 10 psig to about 5000 psig;
e) oxidizing the thus-formed body in an oxygen containing atmosphere at elevated temperatures, for a time period sufficient thereby crosslinking the PPE polymer to form a modified poly(phenylene ether) composite;
f) carbonizing said modified poly(phenylene ether) composite at an elevated temperature in a non-oxidizing atmosphere to form a modified poly(phenylene ether) electrode;
g) activating said modified poly(phenylene ether) electrode with one selected from the group comprising oxidizing gases, bases, or acids at elevated temperatures; and
h) assembling a double layer capacitor with two or more of said modified poly(phenylene ether) electrodes by sandwiching them with a separator in an electrolyte and further stacking with current collectors.

10. The method according to claim 3, wherein the carbon powder particle size is in the range of 1 nanometer to 1 millimeter, with a surface area of 1 m²/g to 4500 m²/g.

11. The method of claim 7 wherein in step (b), the poly(phenylene ether) solution comprises 1-20 wt % of poly(phenylene ether) in solvents selected from the group consisting of chloroform, tetrachloroethylene, trichloroethylene, toluene and combination thereof.

12. The method of claim 7 wherein in step (b), carbonous materials are selected from the group consisting of activated carbon, carbon black, graphite powder, glassy carbon and the combination thereof, the carbon particles having a BET surface area between about 0.5 m²/g and about 4500 m²/g.

13. The method of claim 7 wherein in step (c), the poly(phenylene ether) solution is applied to the carbon fiber fabric by casting, extruding, spreading or immersing.

14. The method of claim 7 wherein in step (d), the drying process is conducted at ambient or higher temperatures until the weight of said body remains constant.

15. The method of claim 7 wherein in step (e), the composites are pressed at pressures between about 1 psig and about 10,000 psig and the temperatures are controlled between about 150° C. and about 300° C.

16. The method of claim 7 wherein in step (f), the stabilization temperatures are between about 100° C. and about 420° C. and the stabilization time is between about 10 min and about 100 h.

17. The method of claim 7 wherein in step (f), the oxidizing step comprises oxidizing agents selected from the group consisting of air, oxygen containing gases, CO₂, other CO₂ containing gases, steam and mixtures thereof.

18. The method of claim 7, wherein in step (g), the activation temperatures are between ambient and approximately 1000° C.; and the oxidization time is between 10 min and 100 h.

19. The method of claim 7 wherein in step (g), the carbonization temperatures are between about 450° C. and about 3000° C.

20. The method of claim 7 wherein in step (g), heating rates employed for the carbonization process are between 1° C./min to 100° C./min.

21. The method of claim 7 wherein in step (g), the non-oxidizing atmosphere comprises nitrogen, helium, argon or vacuum, and the pressure is between 10⁻¹⁰ torr and 10⁵ atm.

22. The method according to claim 7, wherein the porous modified poly(phenylene ether)/carbon fiber formed body has a modified poly(phenylene ether)/carbon fiber weight ratio between 1:10 and 10:1.

23. The method according to claim 7, wherein the porous, modified poly(phenylene ether) carbon/carbon fiber formed body has a modified poly(phenylene ether) carbon/carbon fiber weight ratio between 1:10 and 10:1.

24. The method according to claim 7, wherein the porous, high surface area, activated MPPE carbon/carbon fiber formed body has a surface area greater than 1000 m²/g.

25. The method of claim 8 wherein, the activation agents are selected from the group consisting of air, oxygen containing gases, CO₂, CO₂-containing gases, steam, KOH, NaOH, LiOH and other organic and inorganic bases, H₂SO₄, HNO₃ and other organic and inorganic acids, NₓO_{y}(x=1-2, y=1-3), H₃PO₄, Cl₂ and other halogens, and mixtures thereof.

26. The method of claim 9 wherein in step (h), the separator is an organic or inorganic material with good ion conductivity and high electric resistance, which is selected from the group consisting of cellulose, ion-exchange membranes, porous polyvinylidene fluoride membranes, porous polypropylene membranes, porous ceramic membranes and combinations thereof.

27. The method of claim 9 wherein in step (h), the electrolyte is an organic or inorganic material in the form of either liquid or solid, which contains free ions in normal operation temperatures, said electrolyte being selected from the group consisting of organic or inorganic bases, organic or inorganic acids, organic or inorganic salts and mixtures thereof.

28. The method according to claim 9, wherein the electrode has a specific capacitance greater than 55 F/g.
